(19) United States
(12) Patent Application Publication
(10) Pub. No.: US 2013/0159209 A1
(43) Pub. Date: Jun. 20, 2013

(54) PRODUCT INFORMATION

(71) Applicants: Yong Zhao, Beijing (CN); Cong-Lei Yao, Beijing (CN); Yuhong Xiong, Beijing (CN); Li-Wei Zheng, Beijing (CN)

(72) Inventors: Yong Zhao, Beijing (CN); Cong-Lei Yao, Beijing (CN); Yuhong Xiong, Beijing (CN); Li-Wei Zheng, Beijing (CN)

(21) Appl. No.: 13/817,361

(22) PCT Filed: Aug. 18, 2010
(86) PCT No.: PCT/CN10/76092

§ 371 Date: Feb. 15, 2013

(51) Int. Cl. G06Q 10/06

(52) U.S. Cl. CPC G06Q 10/067
USPC 705/348

(57) ABSTRACT

Disclosed is a method of generating a model representation of product information. The method obtains a list of products from a source of product information. A hierarchical tree is then constructed from the obtained list of products, wherein each hierarchical layer of the tree corresponds to a different category of product information.

### BACKGROUND

Using product information management and search systems, a user may identify products mentioned in text or queries. For example, a user may use a product resolver which is a tool for recognizing and disambiguating products that are contained in user queries and other text.

A product resolver may be required to recognize and disambiguate products from a long list of products. This may be the case when lots of products have similar product names or the same product model numbers, for example. Also, a product may have multiple names with different forms causing a list of such products to be inconsistent in terms of the formatting and/or construction of each item/entry in the list. Further, products may also have associated accessory products, and the names of such accessory products may be very similar to the associated major products.

### BRIEF DESCRIPTION OF THE EMBODIMENTS

Embodiments are described in more detail and by way of non-limiting examples with reference to the accompanying drawings, wherein

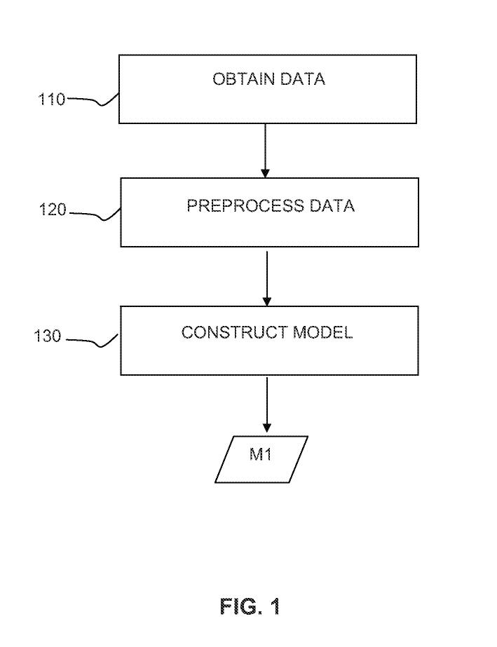

FIG. 1 depicts a flow diagram of a method of constructing a hierarchical model representation of product information;

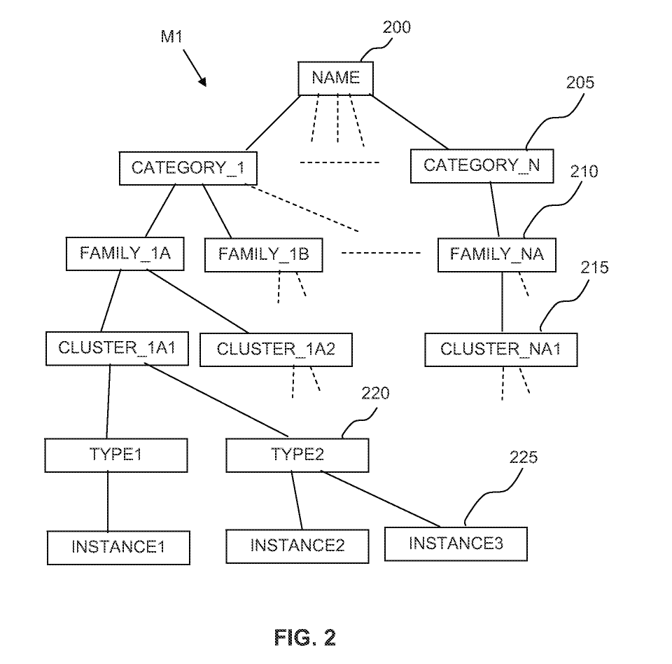

FIG. 2 depicts a hierarchical six-layer tree model for representing a product hierarchy

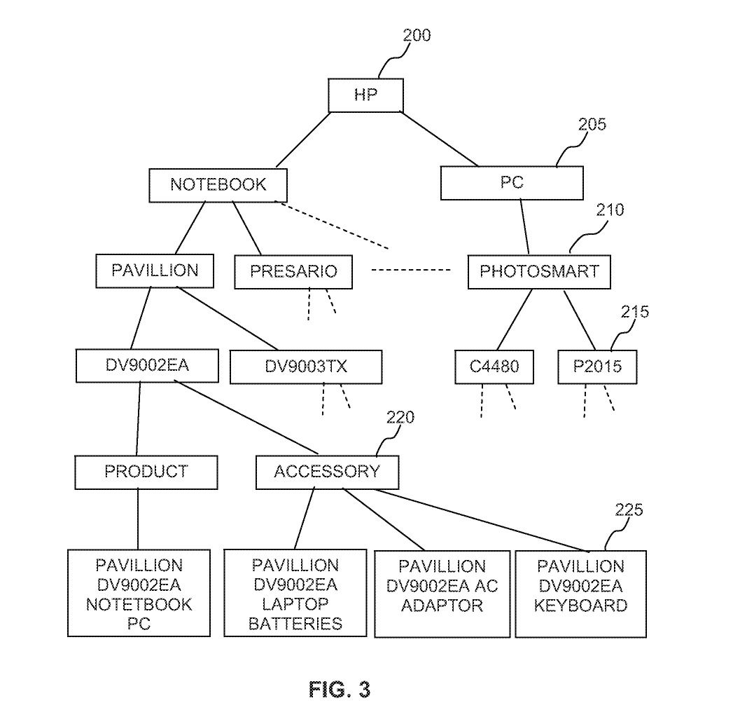

FIG. 3 depicts an example of a hierarchical ee model constructed from obtained product information;

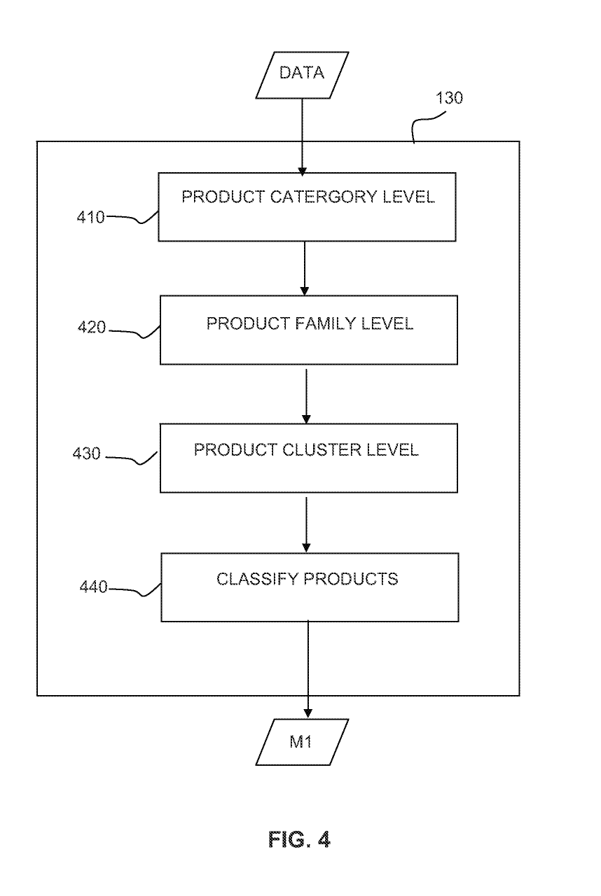

FIG. 4 depicts a flow diagram of the step 130 of constructing a hierarchical model representation of product information; and

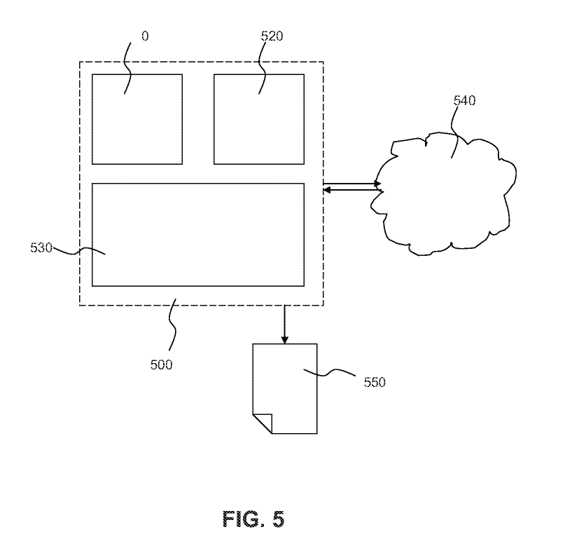

FIG. 5 schematically depicts a system for automatically extracting product information.

### DETAILED DESCRIPTION

It should be understood that the Figures are merely schematic and are not drawn to scale. It should also be understood that the same reference numerals are used throughout the Figures to indicate the same or similar parts.

Since large organizations may produce numerous products, the names of an organization's products may therefore be complicated. It can be difficult to create and/or use a product resolver which is able to recognize and disambiguate products from a long list. A product may have multiple names with different forms causing a list of such products to be inconsistent in terms of the formatting and/or construction of each item/entry in the list and therefore making it difficult to create automatic algorithms which can identify multiple names as relating to the same product.

Proposed is a method of constructing a model representation of product information. The model representation may be a hierarchical tree comprising six-layers corresponding to the product name set, product category, product family, product model number, product type and product instance, respectively. All such layers may relate to product identity and so embodiments may construct a model representation of product identity information (product identity information being information relating to the identity of products).

Such a model may be constructed from a list of product names. For example, from an obtained product name list, a hierarchical product model can be constructed according to an embodiment, and then this model may be used with a product concept resolver to support product search and product disambiguation.

The list of products may be unstructured, meaning the items (i.e. product names) of the list do not adhere to a predetermined format, layout, structure or arrangement.

A structured list is a list of items, wherein every item of the list adheres to a predetermined structure or formatting requirement. Conversely, an unstructured list is a list of items, wherein items of the list do not adhere to a predetermined structure or formatting requirement. Items of an unstructured list may therefore be randomly formatted or structured, meaning little or no information may be implied about an item of an unstructured list from its appearance or existence in the list.

By way of example, an example of a structured list of product names may be as follows:
HP NOTEBOOK PAVILLION DV9002EA COMPUTER
HP NOTEBOOK PAVILLION DV9003TX COMPUTER
HP NOTEBOOK PRESARIO PV901 COMPUTER
HP PC PHOTOSMART C4480 COMPUTER
HP PC PHOTOSMART P2015 ADAPTOR
HP PC PHOTOSMART P2015 KEYBOARD
HP NOTEBOOK PAVILLION DV9003TX ADAPTOR
HP NOTEBOOK PAVILLION DV9003TX COMPUTER
HP PC PHOTOSMART 04480 ADAPTOR

From this example it will be appreciated that each item of this exemplary structured list adheres to a predetermined format which can be summarised as: <manufacturer>space)<product_category>(space)<product_family>(space)<pro duct_number>(space)<product_instance>.

Conversely, an example of an unstructured list of product names may be as follows:

NOTEBOOK PAVILLION HP DV9002EA
HP-PAVILLION-NOTEBOOK-COMPUTER-DV9003TX
HP NOTEBOOK PRESARIO PV901 COMPUTER
PHOTOSMART C4480 PC BY HP
PHOTOSMART (P2015) PC ADAPTOR from HP
HP Photosmart P2015 (Keyboard)
Adaptor—PAVILLION HP DV9003TX NOTEBOOK
HP NOTEBOOK PAVILLION DV9003TX COMPUTER

From this example it will be appreciated that items of this exemplary unstructured list are randomly formatted and do not adhere to a predetermined structure or format.

Creation of a hierarchical tree from an unstructured list may assist the use of automated information extraction algorithms since problems associated with using unstructured information can then be alleviated or avoided.

Using a hierarchical model according to an embodiment, a product resolver may support online product searching and product disambiguation. Such a product resolver may thus provide detailed product information like the product categories, product families, and product model numbers for products mentioned in a user query or text. Also, the product resolver may use the hierarchical model to differentiate major products from accessory products.

The hierarchical model may describe a hierarchy of products. From such a model, a user can acquire information about products, like their product categories, their similar products and their related products, which can be useful for recognizing and disambiguating products.

A semi-automatic method may be used to construct the product category layer, a score based method may be used to construct the product family layer, a confidence propagation method may be used to identify the product cluster layer, and an algorithm may be used to classify the products in a product cluster to major products or accessory products.

A flow diagram of a method 100 of constructing a hierarchical model representation of product information is shown in FIG. 1.

Firstly, product information is obtained from a data store as a list of products in step 110. By way of example, the product information may be acquired by undertaking an internet search for products offered by a particular organization or company.

The product information (i.e. the list of products obtained in step 110) is then preprocessed in step 120. This step of data preprocessing is undertaken to remove incorrect or duplicated product information. For example, product names obtained from an internet search by computer-implemented algorithms may contain errors or duplications which may be problematic when creating a hierarchical product model.

In this example, the preprocessing step 120 replaces special characters such as “(“, “-” and “/” with the space “ ” character, and performs word stemming on each product name. The preprocessing step 120 may also correct wrong words in product names using predetermined heuristics. For example, since it has been noticed that wrong words are typically rare, the preprocessing step 120 checks for rare words (by computing the frequency of occurrence of words) and compares their similar words with common words. If matching, the rare words are determined to be wrong and are replaced by the corresponding common words.

The preprocessing step 120 finally identifies duplicated product names and removes them from the product information.

Next, in step 130, a hierarchical six-layer tree model M1 is constructed using the preprocessed information and output as the result. Such a hierarchical six-layer tree model M1 is illustrated in FIG. 2. The six layers in this tree correspond to the product name 200, product categories 205, product families 210, product clusters 215, product types 220 and product instances 225, respectively.

A specific example of a hierarchical tree constructed in step 130 is illustrated in FIG. 3. Here, the top layer of the model M1 is the “product set layer” 200, which represents all the products of a company named “HP”. The node in the top layer has no parent nodes and so is referred to as the root node. The second layer is the “product category layer” 205, which describes the product categories including “notebook” and “pc”. The third layer is the “product family layer” 210, where each node represents a product family of each product category. Here, for example, “pavilion” and “presario” are the two “product families” of the product category “notebook”. The fourth layer is the “product duster layer” 215, where each node corresponds to all products containing the same product model number of the same product family. Here, for example, “DV9002EA” and “DV9003TX” are the two model numbers of the “pavilion” product family in the “notebook” category. The fifth layer is the “product type layer” 220 in which each node represents a product type. Here, one product type is a “product” and the other product type is an “accessory”.

The sixth and bottom layer is the “product instance layer” 225 where each leaf node in this layer is a specific product name. For example, the product name “PAVILLION DV9002EA NOTEBOOK” is one of the leaf nodes.

In this model, all nodes except the root node have only one parent node, and all nodes except the leaf nodes have children nodes. Thus, it will be understood that for each leaf node, there is only one path from the root node 200 to itself. This provides a detailed and unambiguous definition for each product. For example, for the leftmost leaf node in the FIG. 3, the path from root node to itself is “HP”→“NOTEBOOK”→“PAVILLION”→“DV9002EA”→“PRODUCT”→“PAVILLION DV9002EA NOTEBOOK”. This path indicates that the product “PAVILLION DV9002EA NOTEBOOK” is a “notebook”, which is in the “pavilion” product family, having a model number “DV9002EA” and is product rather than an accessory. Using the hierarchical product model, one can obtain further information. For example, since the leftmost leaf node is a “product”, one can find all of its related accessory products by finding its parent node's parent node, and then finding all descendant leaf nodes of the child “accessory” node.

In this example, a top-down approach is used to construct the product model M1. Specifically, a semi-automatic method is used to construct the product category layer, a score-based method is used to find all product families of the products in each product category, a confidence propagation method is used to construct the product cluster layer of the model, and an algorithm is used to classify all products in a product cluster to major product and accessory products.

The step 130 of constructing a hierarchical product model will now be described in more detail with reference to FIG. 4. FIG. 4 shows a flow diagram of a method of construct a hierarchical product model from a list of products which is provided as a data input.

Firstly, in step 410, the product category level of the model is constructed using a semi-automatic method. Here, it is noted that the products of a single company can be classified into different product categories. For example, a product “PAVILION DV9003EA PC” is of the product category “PC”, and so this product is defined to be within the product category “PC”.

Different product category words are used to represent the different product categories and product types for products. In this way, each node of the product category layer in the product model corresponds to one product category word.

For a given product name list, one can identify product category words in product names. However, this may be time-consuming if the product name dataset is very large. Some product category words may also be missed if there is not an extensive knowledge about all of the products in the dataset.

An automatic method to identify product category words from a product name dataset may be used. This may be based on the finding that most product category words have a high frequency of occurrence and are also noun phrases. The algorithm may be used to identify all noun phrases with a high frequency of occurrence, which are then identified as candidate category words. Product category words may then be selected from the candidates. By way of example, the algorithm may first split products names by space words and count the frequency of occurrence in a list for each n-gram (successive words in a product name with the length of n, 1<=n<=3). Next, a list of candidate n-grams is created from n-grams having a frequency of occurrence exceeding a threshold value. Here, different threshold values may be used for different values of n. Next, a known parser (such as a Stanford Parser) may be used to identify noun phrases in the candidate n-gram set. Product category words may then be selected from the identified candidate noun-phrases.

Next, in step 420, the product family layer of the model is constructed. The products of single companies can typically be categorized into product families. For example, the product “PAVILION DV9003EA NOTEBOOK” is of the product family “PAVILION”. A product category typically contains multiple product families. For instance, the category “PC” in HP products contains product families named “PAVILION”, “PRESARIO”, “HDX” and so on.

If one does not have any knowledge of the products of a company, it may be difficult to identify product family words in a description of a product, such as “HDX C2D 2.4 GHZ 20.1 WUXGA BLURAY LAPTOP NOTEBOOK PC” for example.

After analyzing a large number of product names and product categories, various features of product family words have been identified. The first feature is that most products usually have single product family words. The second feature is that the product family words are usually near the beginning of the product names. The third feature is that each product family word does not normally contain a number. The final feature is that the product family words of the same product category frequently appear only in product names of that category, and rarely appear in product names of other product categories. Taking account of these findings, an algorithm can be created which uses these features to identify product family words of each product category. An example of such an algorithm is summarised as follows.

### Function

Compute Product Family Words for each Product Category

Input
PN: Product Name Dataset
PCW: Product Category Word Set

Output
PFW Product Family Word Set for each product category

Begin
(1) For each product category c:
   Select the Category Product Dataset (CP) of w, all products in CP contain the w
   Split the product names in CP by blank space, then remove words with a number—the removed word set is then called the Candidate Word Set (PW(c))
   Count the category document frequency for reduced words. This is called DF(cw, c), which is the number of products in CP containing word cw.

(2) For each product category c:
For each word cw in PW(c)
   Compute the score of cw using the following formulas (1) and (2):

$$\begin{matrix}score ( c , cw ) = ( {\sum }_{i = 1}^{10} \frac{{r}_{i}}{i} ) * ( \frac{DF ( cw , c )}{{\sum }_{{c}_{j} inPCW} DF ( cw , {c}_{j} )} ) & ( 1 ) \\ {r}_{i} = \frac{\begin{matrix}The\_number \_of \_product \_ \\ names\_with \_c \_in \_the \_location \_of \_i\end{matrix}}{DF ( cw , c )} & ( 2 )\end{matrix}$$

Return cw which score(c,w) is larger than a predefined threshold.

In step 430, the product cluster layer is constructed. Each family typically consists of multiple products and associated accessories, where the products (and their accessories) of a family are often differentiated from each other using product model numbers. For example, “DV9002EA” and “DV9003TX” are two product model numbers of a company's products.

A product model number often corresponds to a plurality of individual items associated with a single main product, and may be used to group items with the same product model number into a single product cluster. One may therefore identify product model numbers in the product names of a product family in order to discover the product clusters of a product family. However, different product families may have different forms of product model numbers, and the same product family might have different kinds of model numbers. It may therefore be difficult to identify the model numbers in a product family.

To address the aforementioned problem, embodiments may use a confidence propagation method to identify product model numbers in a product family. Using the identified product model numbers, the products may then be grouped into clusters.

An exemplary method for identifying product model numbers of a product family is summarised as follows.

Function
Trust Rank algorithm to find product Model Numbers

Input
D: Product Name Dataset of a Product Family

Output
T: Ranked model numbers

Begin
(1) Scan the Product name of D and find a Candidate Model Number Set C.
(2) For each candidate model number c in C, find its neighbors S(m) by using distance based similarity and context based similarity.
(3) Use all candidate model numbers c in C as node and each (m,n), where n in S(m) as edge to construct a graph.
(4) Select some reliable model numbers as seed nodes by using heuristic rules, and give positive confidence score only to seed nodes of the graph.
(5) Use the known TrustRank algorithm to transport the confidence score to other nodes and rank the all nodes by the results of the algorithm. Finally output the ranked results.

In summary, this algorithm firstly finds some reliable model numbers as seeds, and then employs a confidence propagation method to propagate the confidences of seeds in order to discover other reliable model numbers. It will be understood that this algorithm contains five steps.

The first step is to find the candidate model number set. Here, it has been noticed that all product model numbers contain a number, and so one may use a simple algorithm to find the candidate model number as follows: Scan the product names of a product family, and if a word in product name contains a number, it is added to a Candidate Model Number Set C.

The second step is to compute the similarities between candidate model numbers. Here, two kinds of similarities are computed.

The first similarity is the edit distance between words, which is based on the following intuition: if the word likes “NC6220” is a real model number in a product family, then the similar words like “NC6440” would also be the real model number with high possibility. Typically, similar products use some similar model numbers, and the edit distance between them is very small. The edit distance is therefore used to measure the similarity between the candidate model numbers. The Levenshtein distance is used to measure the edit distance due to its proven efficiency. By way of example, Equation 3 below may be used to compute the first similarity based on the edit distance between words.

$${S}_{e} ( α , β ) = 1 - \frac{2 * dis ( α , β )}{len ( α ) + len ( β ) + dis ( α , β )} , \qquad ( 3 )$$

where len(α) is the number of characters in α, and dis(α,β) is the Levenshtein distance between α and β, Sₑ(α,β) is the edit distance-based similarity between α and β. It will be appreciated that the example of Equation 2 uses a normalized form of edit distance to measure the similarity.

The second similarity is computed between the context words of candidate model numbers. Firstly, for each candidate model number in the product dataset, the product list is searched to get product names including the candidate number. All the words except the candidate model numbers are then combined into a word bag. Secondly, a word vector is generated for each word bag, in which each element is the frequency of the corresponding word. Finally, a cosine-based similarity between the generated vectors in calculated. Such a context similarity between α and β is S_{c}(α,β).

The first and second similarities are then linearly combined, as exemplified by Equation 4:

S(α,β)=a*Sₑ(α,β)+(1−a)*S_{c}(α,β) (4),
where Sₑ(α,β) is the edit distance based similarity (as calculated by Equation 3 for example), S_{c}(α,β) is the context words based similarity, and S(α,β) is the combined similarity between α and β.

The third step for identifying product model numbers of a product family is to construct a word graph, in which each node corresponds to each candidate model number, and the weight of each edge is equal to the similarity between two candidate model numbers (nodes).

The fourth step is to select some reliable model numbers as seeds using heuristics. For example, if a product name contains only the candidate model number after removing the product family word and product category word, it is added to a seed set. A candidate model number is also selected by computing a score on the product set in which all product names contain the candidate model number. If all products are similar in word distribution, the score is determined to a high value and it is selected as a reliable model number.

The fifth and final step is to use the known TrustRank algorithm (see paper entitled “Combating Web Spam with TrustRank” by Z. GyÄ ongyi et al in Proceedings of VLDB, 2004, pages 576-587) to propagate the confidences of seed model numbers to neighbours, and finally rank all candidate model numbers.

Having grouped all products of a single family into clusters (based on their associated model numbers), the method of generating a product model then continues to step 440 in which grouped/clustered products are classified into product types. Here, all products are classified into one of two types: major product and accessory product. For example, the product “PAVILION DV9002EA NOTEBOOK” is a major product, whereas the product “PAVILION DV9002EA AC ADAPTER” is an accessory product of the major product.

An exemplary approach to classifying the products in a product cluster into major products and accessory products comprises the step of assessing the end of the product name. If a product name ends with its product category word, it is classified as a major product, whereas it is otherwise classified as an accessory product.

A hierarchical tree model according to an embodiment may provide a great deal of information about the product information it has been generated from, which may be useful for recognizing and disambiguating products.

Embodiments may be captured in a computer program product for execution on the processor of a computer, e.g. a personal computer or a network server, where the computer program product, if executed on the computer, causes the computer to implement the steps of the method, e.g. the steps as shown in FIG. 1. Since implementation of these steps into a computer program product requires routine skill only for a skilled person, such an implementation will not be discussed in further detail for reasons of brevity only.

In an embodiment, the computer program product is stored on a computer-readable medium. Any suitable computer-readable medium, e.g. a CD-ROM, DVD, USB stick, Internet-accessible data repository, and so on, may be considered.

In an embodiment, the computer program product may be included in a system for recognizing and disambiguating products, such as a system 500 shown in FIG. 5. The system 500 comprises a user selection module 510, which allows a user to tell the system 500 the product he wants the system 500 to identify and provide information about.

The system 500 further comprises a product Information module 520. The hierarchical tree generating module 520 is responsible for obtaining and/or storing product information from a source of product information such as a network 540 (like the Internet or a company network, for example).

In an embodiment, the user selection module 510 and the product information module 520 may be combined into a single module, or may be distributed over two or modules.

The system 500 further comprises a hierarchical tree generating module 530 for generating a tree model representation of product information in accordance with a proposed embodiment and presenting product information to the user or subsequent applications in any suitable form, e.g. digitally or in text form, e.g. on a computer screen or as a print-out 550.

It should be noted that the above-mentioned embodiments illustrate rather than limit embodiments, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. Embodiments can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of generating a model representation of product information, the method comprising the steps of:
using a computer, obtaining a list of products from a source of product information;
using a computer, constructing a hierarchical tree from the obtained list of products, wherein each hierarchical layer of the tree corresponds to a different category of product information.

2. The method of claim 1, wherein the list of products is an unstructured list comprising product names that are do not adhere to a predetermined format

3. The method of claim 1, wherein a layer of the hierarchical tree corresponds to at least one of: a product name set; a product category; a product family; a product model number; a product type; and a product instance.

4. The method of claim 3, wherein the hierarchical tree comprises layers corresponding to a product name set, a product category, a product family, a product model number, a product type and a product instance, respectively.

5. The method of claim 1, further comprising the step of, prior to the step of constructing a hierarchical tree, preprocessing the obtained list of products using a computer to remove incorrect or duplicated products.

6. The method of claim 1, wherein the step of constructing a hierarchical tree comprises, using a computer, constructing a product category layer based on the frequency of occurrence of terms in the obtained list of products.

7. The method of claim 1, wherein the step of constructing a hierarchical tree comprises, using a computer, constructing a product model number layer using a confidence propagation method.

8. The method of claim 7, wherein constructing a product model number layer comprises the steps of
using a computer, identifying candidate model numbers in the obtained list of products;
using a computer, computing the similarities between the candidate model numbers;
using a computer, identifying reliable model numbers based on the computed similarities;
using a computer, employing a confidence propagation method to propagate a measure of confidence of reliable model numbers to candidate model numbers; and
using a computer, ranking the candidate model numbers according to their associated measure of confidence.

9. A method of automatically extracting product information from a source of product information, comprising:
using a computer, providing a product query comprising a request for information related to a product;
generating a model representation of product information according to claim 1;
using a computer, extracting product information based on the disambiguated product query and the generated model representation.

10. A product information management method comprising the steps of:
using a computer, storing product information in data storage means.
generating a model representation of product information according to claim 1, wherein the source of product information is the data storage means.

11. A computer program product comprising computer program code adapted, when executed on a computer, to cause the computer to implement the steps of:
obtaining a list of products a source of product information;
constructing a hierarchical tree from the obtained list of products wherein each hierarchical layer of the tree corresponds to a different category of product information.

12. A computer-readable medium having computer-executable instructions stored thereon that, if executed by a computer, cause the computer to implement the steps of:
obtaining a list of products from a source of product information;
constructing a hierarchical tree from the obtained list of products, wherein each hierarchical layer of the tree corresponds to a different category of product information.

13. A system comprising a computer and the computer program product of claim 11.
